(19) United States
(12) Patent Application Publication
(10) Pub. No.: US 2017/0172190 A1
(43) Pub. Date: Jun. 22, 2017

(54) METHOD AND DEVICE FOR PRODUCING FOOD PRODUCTS, IN PARTICULAR SLEEVELESS PRODUCTS OF A SPECIFIC FORM

(71) Applicant: ALBERT HANDTMANN MASCHINENFABRIK GMBH & CO. KG, Biberach (DE)

(72) Inventors: Daniel TEUFEL, Schemmerhofen (DE); Achim WERNER, Maselheim (DE)

(21) Appl. No.: 15/379,807

(22) Filed: Dec. 15, 2016

(30) Foreign Application Priority Data
Dec. 16, 2015 (EP) 15 200 441.2

(51) Int. Cl. A23L 13/60; A23P 30/00

(52) U.S. Cl. CPC A23L 13/65; A23P 30/00; A23V 2002/00

(57) ABSTRACT

The present disclosure relates to a method and a device for producing food products, in particular sleeveless products of a specific form with the following steps: entry of form parameters, display of the form of the food product as a function of the entered form parameters as a 2D or 3D graphic, calculation of process parameters as a function of the entered form parameters.

### CROSS-REFERENCE TO RELATED APPLICATIONS

The present application claims priority to European Patent Application No. 15 200 441.2, entitled “METHOD AND DEVICE FOR PRODUCING FOOD PRODUCTS, IN PARTICULAR SLEEVELESS PRODUCTS OF A SPECIFIC FORM,” filed Dec. 16, 2015. The entire contents of which are hereby incorporated by reference for all purposes.

### TECHNICAL FIELD

The present disclosure relates to a method and a device for producing food products, in particular sleeveless products in a predefined form.

### BACKGROUND AND SUMMARY

Different methods for forming of pasty products are already known in the food industry. For example, a method is known in which two form plates are moved against one another in a linear way in order to change the cross-section of the throughput opening through which a food strand is conveyed. Food products such as sausage-shaped products, balls or cylindrical form parts with rounded ends or drop-shaped products etc. may be produced with corresponding methods.

Also, so-called diaphragms, which have several separating elements that can move to open and close in form of an iris panel, are already used to produce for example rounded edges, balls, etc.

Different parameters may be entered into a machine during production of formed food products. The operator can only judge to a limited extent how the form actually looks like. Through adjustment of a parameter, the form will not only change in the desired directions in most cases, but the proportions of the overall form will change. Then, the form will have to be corrected again by means of further parameter changes. To be able to monitor and/or determine the product form, however, the product has to be produced at first. Only now, the product form can be evaluated. Subsequently, the product form can be changed once again through setting of parameters. However, the product will then have to be produced once again in order to evaluate the new product form. This process is repeated until the desired form is set. In many cases it is also difficult to intercept the manufactured food product after having been produced in order to evaluate the form. If the system is located for example on top of a scalding tank into which products are falling or if production runs at a high speed, intercepting and evaluating the products will be difficult.

Based on this, the purpose of the present disclosure is to provide a method and a device for producing formed food products, in particular sausages, which enable a simple and exact setting of a desired food product form.

According to the present disclosure, form parameters are entered into a corresponding machine and/or a machine control for the production of food products of a defined form. Then, the form of the food product may be displayed on a respective screen as a 2D or 3D graphic as a function of these form parameters. Hence, the operator may detect the form of the food product immediately as a function of the entered form parameters. If the operator adjusts a form parameter, he will be able to see immediately how a respective change impacts on the proportions of the overall form. The operator can therefore correct the form without having to produce a corresponding food product at first. Consequently, the operator may produce a desired food form much faster than in the state of the art. Maladjustments may be detected and corrected immediately. By means of changing individual form parameters, the operator may set the desired form in a simple way as he sees it immediately as a graphic display. On the basis of the respective form parameters, process parameters may subsequently be calculated on whose basis the device for producing and forming of the food products will then be activated. The method according to the present disclosure consequently allows for time as well as cost savings and enables the production of food products with an optically attractive form.

In the method according to the present disclosure, also the order of the last two process steps may be inverted, i.e. the method steps may not be restricted to the specific order of displaying the form of a food product as a function of entered form parameters as a 2D or 3D graphic and then calculating process parameters as a function of the entered form parameters. This means that the form of the food product can be displayed graphically as a function of the entered form parameters and that the form parameters can be calculated only then or at the same time as a function of the form parameters, e.g. by using the entered form parameters or the calculated graphic data.

It is also possible that the process parameters may be calculated as a function of the form parameters and that the respective form of the food product is subsequently displayed graphically. In this context, the graphic data can be calculated either for example by using the entered form parameters or rather by using the calculated process parameters.

The graphically displayed form of the food product can be changed by entering modifiable form parameters. This means that the operator can change the form, which is displayed as a graphic, until all parameters represent the desired form. When the form parameters are changed, the displayed form of the food parameter on the screen changes accordingly and respectively changed process parameters are calculated. The process parameters can thereby either be modified along with each change (and/or calculated) or only be calculated when the operator confirms a defined selected form of the food product. This means that, if it is determined that the food product should be produced on the basis of a specific displayed form, a confirmation will be entered after which the food can be produced.

For example at least one parameter out of the following group can be entered as a form parameter: length of the formed food product, diameter of the formed food product, in particular sausage caliber, length of the front and/or rear tip of the food product, length of the food product with a constant diameter, change of the diameter as a function of the food product length, number of diameter changes per path.

Advantageously, the food products may be produced with a forming device that is formed in a way that the cross-section of a throughput opening, through which a food strand is transported for forming, is changed as a function of the time or of the traveled ejection path of the product. Hence, the form of the food product can be designed in any way. The forming device may comprise at least two, and in at least one example, more than two flat displacer elements that may be superimposed in the transport direction of the food strand and that have each at least one opening through which the food strand can be moved in the transport direction. This device further comprises a movement mechanism for moving the flat displacer elements (in at least one example, on a curved track) in a way that the respective openings can be moved in relation to one another so that the cross-section area of the resulting overall opening of the overlapping openings changes.

At least one parameter out of the following group can be calculated as a process parameter: conveying capacity of the food, in particular conveying capacity as a function of time. This means that either a specific constant conveying capacity of the food is set, for example by means of setting the conveying capacity of a conveyor pump of a filling machine, or rather the conveying capacity varies in order to produce defined product forms. Also the speed of the abovementioned displacer elements at defined points in time and/or as a function of time and/or over the length of the product can be calculated. Further, the direction of the movement of the displacer elements can be calculated. Also the position of the displacer elements as a function of time, i.e. over the length of a food product, can be calculated in such a way that an opening with a defined cross-section area is formed on the respective positions of the product to be produced. Also the position of a separator blade, e.g. for cutting and forming of minced meat, can be calculated as a function of the time or of the traveled ejection path of the food product and where applicable also the speed of the transport medium on which the product, e.g. the minced meat, is conveyed. In this process, the separator blade can be moved in a direction that is oblique or perpendicular to the transport direction of the food product and/or optionally also in or opposite to the transport direction.

The form parameters can for example be entered as a numerical value via an input unit, for example by means of entering a corresponding number through a keyboard or by entering a respective value or a percentage figure via +/−keys.

However, it is also possible to change the form of the graphically displayed food on the graphic user interface of a screen. This can in particular be done by means of a touchscreen. Here, the operator can change for example the dimensions by means of extending or contracting the displayed product form. For example at least one symbol or cursor, which the operator can seize with his fingers, can be displayed in this process. According to a further embodiment, the operator can also start simply in the outer area of the displayed product.

As an alternative to a touchscreen, also a movable symbol, via whose movement the form of the food can be changed, for example by using the direction arrows of the keyboard, can be displayed on the graphic user interface of the screen. The movable symbol can also be a mouse pointer.

Hence, it is also possible that the form of the food changes by moving a mouse pointer, which is displayed on the graphic user interface of the screen, by means of a mouse. The mouse pointer is then placed on an outer area of the displayed form or on at least one displayed symbol.

It is also possible to record a contour on the screen or to import a graphic into the control system 25 and to use it for further processing of the data.

If a form is set (for example by means of a mouse pointer or another entry), which cannot be created by means of the forming device used, for example an acoustic or optical warning signal will be emitted. In this process, the parameters, which the operator has to adapt so that the form can be produced, change for example their color. The operator may also be told by an indication in which direction he needs to set the parameter so that the form can be produced. If the form is changed on the graphic user interface and if a form, which cannot be produced, is set, for example also a warning signal will be displayed or emitted or rather the form will be corrected automatically to a form that is as similar as possible.

If both an input unit for numerical values as well as a change on the graphic user interface of the screen are provided, the values changed in an input unit will also change simultaneously for the other entry unit and will be displayed there accordingly.

A device for producing food products comprises a device for ejecting a food strand, for example a filling machine. A forming device for forming of the food products is adjacent to this device. Furthermore, the device has an input unit for the entry of form parameters. Eventually, the device comprises a first calculation device for calculation of process parameters as a function of the form parameters. In addition, the device comprises a screen to display the form of the food product as a 2D or 3D graphic as a function of the entered form parameters. It is also sufficient to display only one side of the rotationally symmetric products. It is also possible to display the form from multiple perspectives.

The device can also have a second calculation device for calculation of graphic data as a function of the entered parameters. It is irrelevant for this process whether the second calculation device computes the graphic data by using the entered form data or on the basis of the already calculated process data.

The food products can be produced with a forming device that is formed in such a way that the cross-section of a throughput opening, through which a food strand is transported, varies as a function of the time or of the traveled ejection path of the product. According to at least one embodiment, the device comprises at least two, and in some examples, more than two flat displacer elements that are superimposed in the transport direction T of a food strand and that have each at least one opening through which the food strand can be moved in the transport direction and a movement mechanism for moving the flat displacer elements in a way that the respective openings can be moved in relation to one another so that the cross-section area of the resulting overall opening of the overlapping openings changes. In at least one example, the displacer elements are moved respectively on a curved track. The flat displacer elements can not only form the food but also cut it completely if the cross-section area of the resulting overall opening is 0. Hence, a separate cutting tool can be omitted.

The device according to the present disclosure can further have an input unit that is formed in a way that numerical values can be entered and/or that the form of the graphically displayed food product is modifiable, in particular by means of a touchscreen or of a movable symbol on the user interface.

Further, a confirmation feature, e.g. in form of a button or an entry option, can be provided to confirm that the food product should be produced on the basis of the displayed food product.

The food products, in particular minced meat products, can be formed with a forming device that is formed in a way that a separator blade moves into the minced meat strand, separates and forms such minced meat strand, wherein the position of the separator blade is changed as a function of time or of the traveled ejection path of the food product.

It is possible that, according to at least one embodiment, at least one process parameter, in particular the conveying capacity, can be entered into the device for example via an input unit and that further process parameters are calculated as a function of the at least one entered process parameter and the entered form parameters.

In the following, the present disclosure will be explained in greater detail with reference to the following figures.

### BRIEF DESCRIPTION OF THE FIGURES

FIG. 1 shows an operating unit for entry of form parameters and display of the form of the food product.

FIG. 2 shows a flow chart for an embodiment for a method according to the present disclosure.

FIG. 3 shows a flow chart for a further embodiment for a method according to the present disclosure.

FIG. 4 shows a rough schematic side view of a device for producing food products with a filling machine and with a forming device.

FIG. 5 shows a rough schematic top view of a filling flow divider with a forming device.

FIG. 6 shows a rough schematic side view of a forming device with three flat displacer elements.

FIG. 7A shows the displacer elements on their curved track in an open position.

FIG. 7B shows the displacer elements in a second example position.

FIG. 7C shows the displacer elements in a third example position.

FIG. 7D shows the displacer elements in a fourth example position.

FIG. 7E shows the displacer elements in a fifth example position.

FIG. 7F shows the displacer elements in a sixth example position.

FIG. 8 shows an operating unit for the entry of form parameters and display of the form of a minced meat product.

FIG. 9 shows an operating unit for the entry of form parameters and display of a sausage form.

FIG. 10 shows displacer elements of a forming device according to a further embodiment.

### DETAILED DESCRIPTION

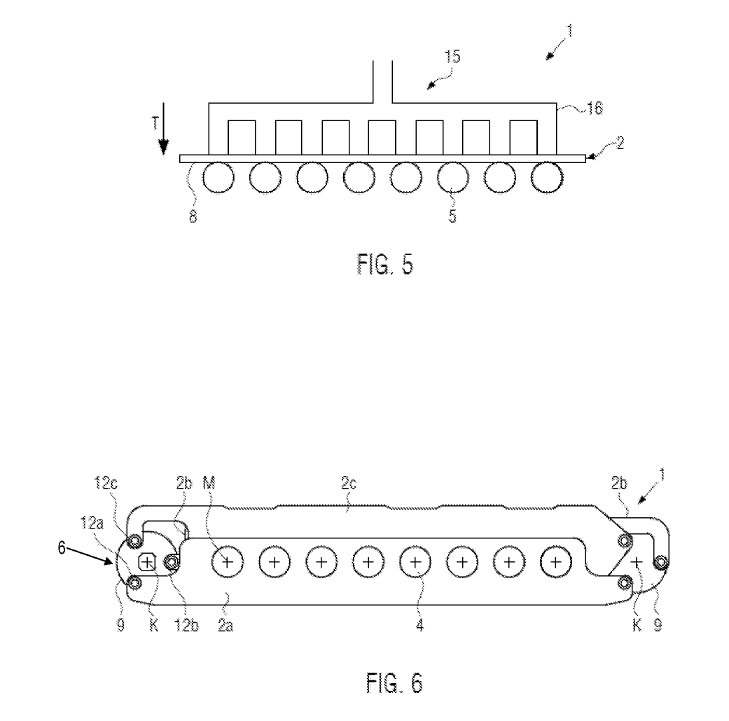

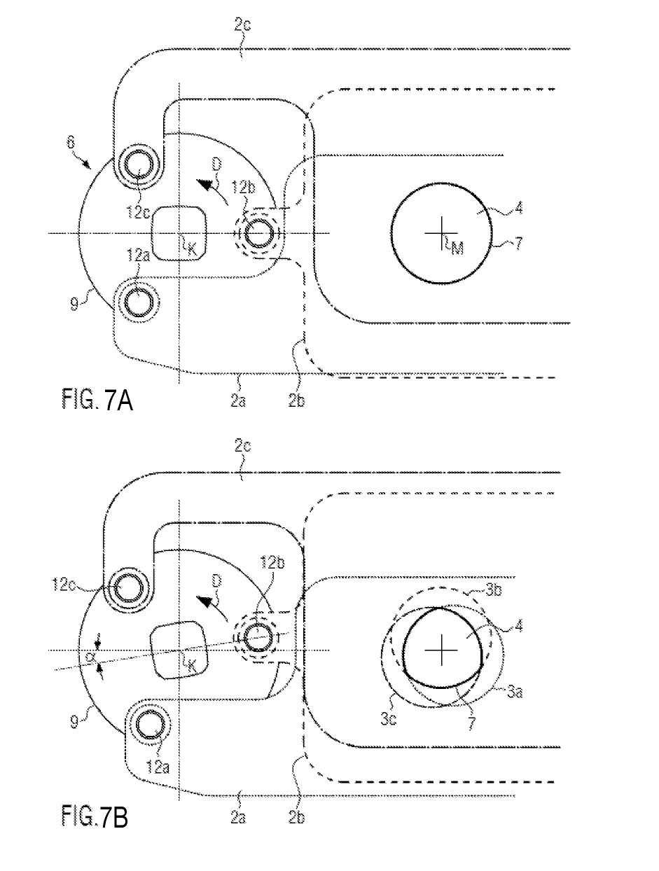

FIG. 4 shows a device for producing formed food products with a device 10 for ejection of a food strand, here a filling machine 10 as well as a forming device 1. The filling machine 10 has a funnel 13 for the intake of pasty material, i.e. of pasty food such as sausage meat or potato mash etc. The pasty food can for example be lifted by means of a meat wagon 20 and a respective lifting device and poured into the funnel 13. Below the funnel, there is a conveyor system that is not displayed specifically, in particular a vane pump that pushes the pasty food into a filling element 15. The filling element 15 can comprise for example a filling tube out of which the food is ejected. The filling device can, as is shown in particular in FIG. 5, comprise a filling flow divider 16 that divides the filling flow and that ejects for example eight products in parallel to one another out of multiple ejection openings. The filling machine further has a control unit 22 that for example also has the calculation devices for the graphic data and/or process data that depend on selected form parameters. In addition, the filling machine has a display field and/or a screen 21 that will be explained in greater detail in the following.

To form the ejected food strand, the forming device 1 is provided according to the present disclosure which, as can in particular be seen in FIG. 5, is disposed tightly on the ejection openings 8 of the filling flow divider or rather of the ejection opening 8 of the filling tube.

The forming device may be formed in a way that it has a throughput opening 4 whose cross-section can change as a function of time or of the traveled ejection path, in such a way that the outer contour of the food can be formed or rather that the food can be separated from the food strand. In this context, the forming device should not be limited to a particular embodiment. Hence, for example a diaphragm with multiple separating elements, which can move to open and close in form of an iris panel, can also be used.

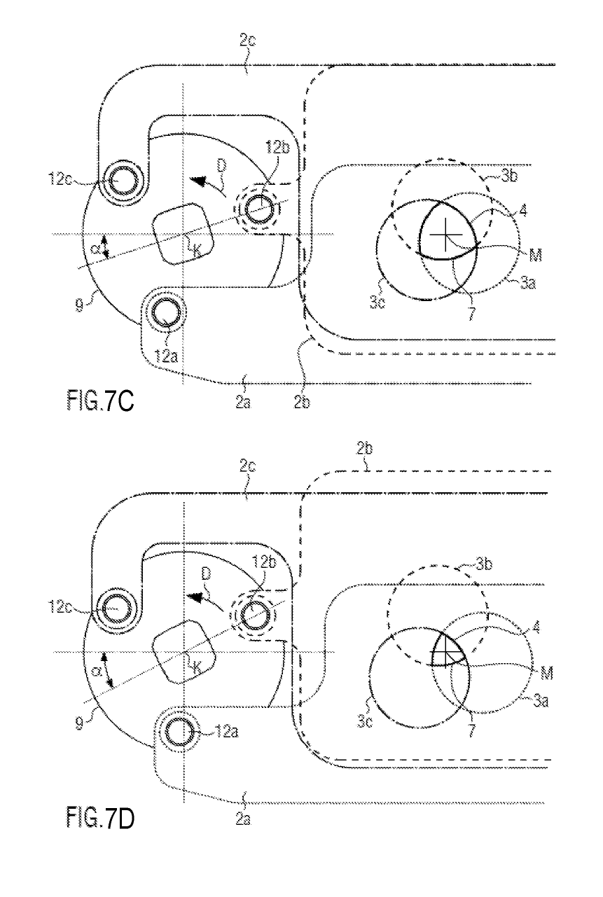

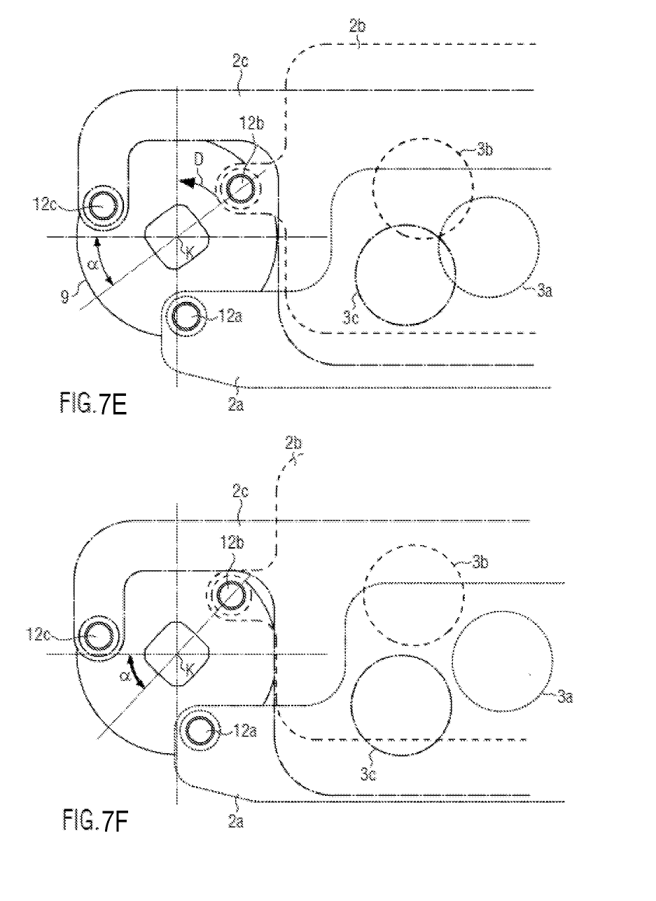

An example embodiment will be explained in greater detail in the following with reference to the FIGS. 6 to 7F.

In at least one example, control unit 22 may form a portion of a control system 25. Control system 25 may be a machine control of the filling machine, for example. Control system 25 is shown receiving information from a plurality of sensors 26 and sending control signals to a plurality of actuators 27 (various examples of which are described herein). However, in some examples, the control system 25 may only include one sensor and/or one actuator. As one example, sensors 26 may include a user input device. For example, the user input device may be a screen 21, wherein the screen 21 may be a touch screen. In other examples, sensors 26 may include a user input device, wherein the user input device is a mouse pointer.

The control unit 22 may receive output signals from at least one of the sensors 26 (e.g., user input device), process the output signals, and trigger at least one of the actuators 27 in response to the processed output signals based on an instruction or code programmed therein corresponding to one or more routines. These actuators 27 may form an actuation system, and a control unit 22 may actuate actuators 27 of the actuation system based on signals received from sensors 26. In some examples, via the control unit 22 actuating actuators 27 of the actuation system based on received signals from sensors 26, the methods described herein may be carried out.

In embodiments where the actuators 27 may include a screen 21, control unit 22 may cause screen 21 to provide a display of graphical results for a form of a food product via user inputs received by one or more sensors 26. In other examples, where actuators 27 may include a forming device for forming a food product, the control unit 22 may actuate the forming device (e.g., displacer elements of the forming device) in response to receiving output signals from sensors 26 to form a food product. For example, the control unit 22 may actuate a rotary drive of the displacer elements. In at least one embodiment, the control unit 22 may also control actuators to adjust a conveying speed of a food product. Additionally or alternatively, control unit 22 may control other actuators of the system necessary to achieve the desired form of a food product, such as pumps, for example. In at least one example, control unit 22 may determine via output received from sensors 26 that the graphic of a form of a food product has been altered, and the control unit 22 may calculate new processing parameters in order to achieve the altered graphic of the food form and display these new processing parameters. Additionally or alternatively, the control unit 22 may produce food products based on the output signals that the control unit 22 receives via sensors 26 indicating that the graphic of a form of a food product has been altered.

Furthermore, methods according to the present disclosure may be carried out by control system 25, and instructions for methods according to the present disclosure may be stored at control unit 22 as executable instructions in non-transitory memory. Instructions for carrying out methods according to the present disclosure may be executed by control system 25 based on instructions stored on a memory of the control unit 22 and in conjunction with one or more sensors and actuators, including signals received from sensors 26, such as the sensors described above, and signals sent to actuators. The control unit 22 may employ system actuators 27 such any one or combination of drives for adjusting the displacement elements, actuators for displaying a form graphic and/or processing parameters on a screen, and actuators for carrying out any one or more of the adjustments that may be entered via the user input device, for example.

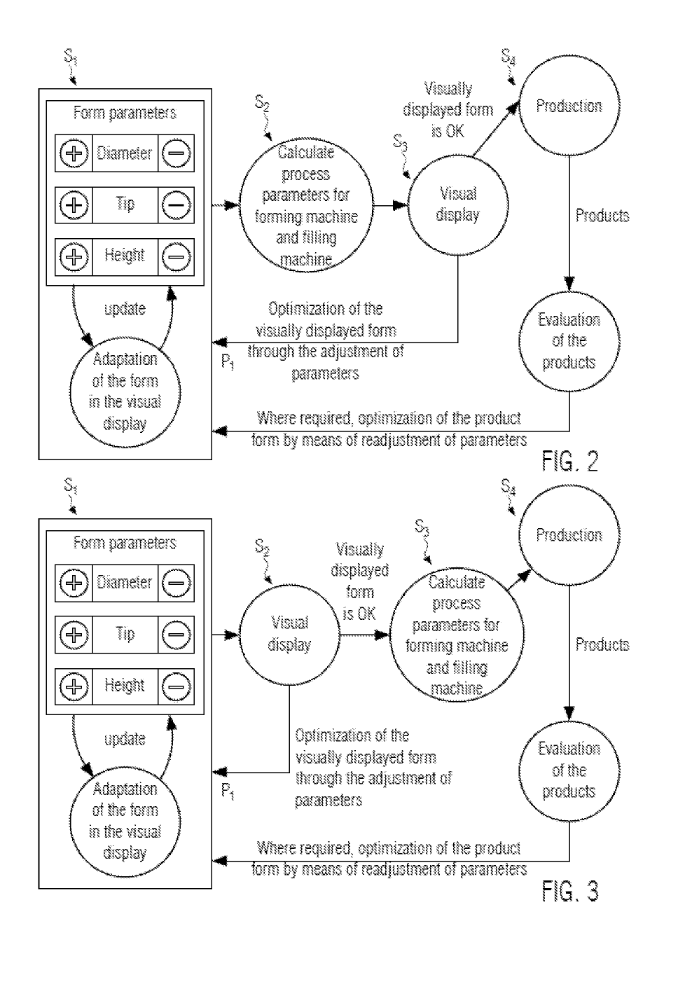

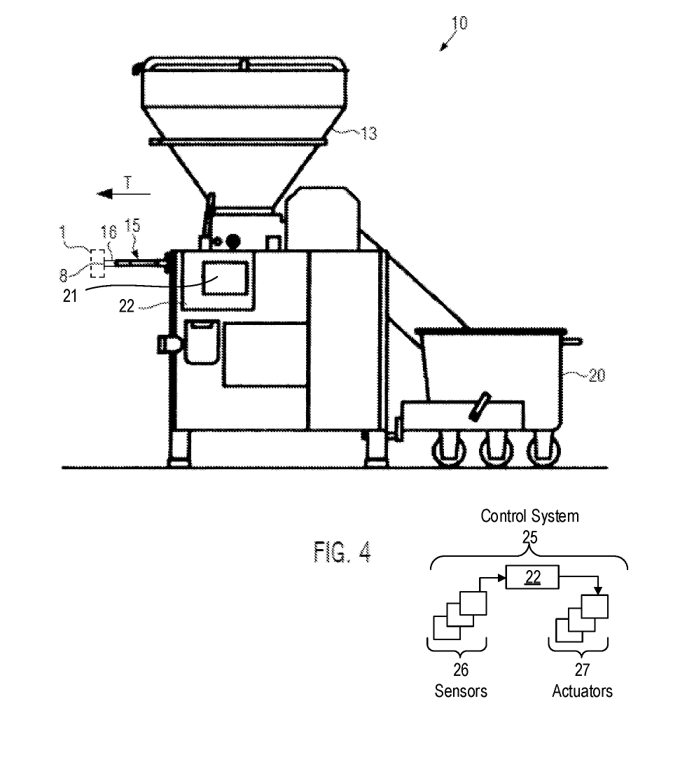

In at least one example, the control system 25 may carry out a first example method comprising receiving entry of form parameters, displaying of a form of a food product as a function of the entered form parameters as a 2D or 3D graphic, and calculating corresponding process parameters as a function of the entered form parameters. These form parameters in the first example method may be received via a user input device, for example. Furthermore, the control system 25 may carry out the other methods described herein, in at least one embodiment. Additionally or alternatively, any one or combination of the steps in the methods described at FIGS. 2 and 3 may be carried out via the control system 25 that is described above.

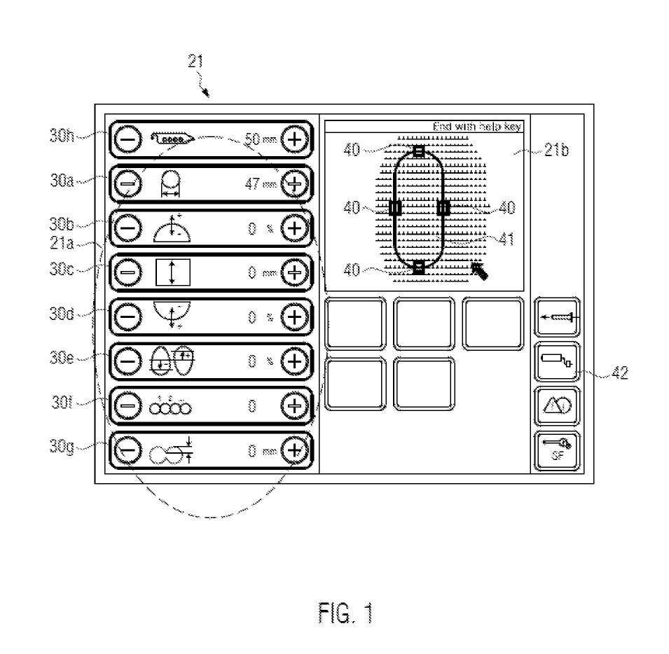

FIG. 1 shows an operating unit, here in form of a screen 21. The screen 21 comprises an input device 21a that is formed in a way that numerical values can be entered for a variety of form parameters (e.g. via a touchscreen or keys). As a form parameter, the diameter of the food product can be entered as a numerical value for example in the field 30a. Here, the amount of the numerical value can be set for example, and as for all remaining parameters, by using a +/−key. If a touchscreen is used, the numerical value can also be entered directly. As shown in the field 30b, the tip form can be set. Here, the front tip can be produced, e.g. based on a tip that has a hemispherical form, with a sharper or flatter shape than the second tip, for example by entering a percentage value, wherein e.g. the tip radius is equivalent to half of the caliber, i.e. the form of the product end can be predetermined from an almost evenly cut shape up to an elongated point. As can be seen in field 30c, also the length of the food product can be entered with a constant diameter. The field 30d is essentially equivalent to the field 30b and relates to the opposite second tip of the food product. In the field 30e, a drop-shaped profile of the food can be set. This means that here, the change of the diameter can be set based on the length of the product, and/or the change of the diameter within a predefined range. In this specific embodiment, a percentage change of the diameter can be set in a range starting from the center of the product.

Field 30f can be used for a product whose diameter changes periodically. Here, the number of connected sections of the product with an identical form can be set. In field 30g, the diameter and/or in this case the depth of immersion of the displacer elements of the food of a specific form (e.g. spherical form) to be produced can be set for this purpose.

In field 30h, the diameter of an opening in a displacer element of a forming device can be set as a form parameter—in accordance with the displacer element used for a corresponding process—as it is possible to use and/or to install displacer elements with different opening sizes for different processes.

Hence, form parameters can be entered as numerical values via the input unit 21a. Out of this form parameters, a respective calculation device will then calculate corresponding graphic data, wherein the form of the food product can be displayed as a function of the entered parameters in the display field 21b as a 2D or 3D graphic. Hence, the operator can immediately record the product form that arises based on the selected form parameters and immediately take appropriate corrective measures without the need to produce the food product specifically for this purpose. The operator can see immediately how a defined parameter changes the overall form.

Alternatively or in addition, also the form of the graphically displayed food product can be changed on the screen 21b. This can for example be ensured due to the screen, at least the section 21b, being formed as a touchscreen and the form being changed through expansion or contraction of the product form. The graphic data are equivalent to the form data.

However, also movable symbols 40 can be displayed on the screen, which are then movable in predetermined directions, for example by clicking on them and by using direction arrows or by means of a mouse pointer. A mouse pointer can also be placed directly on the outer contour of the displayed food form and hence also change the form accordingly by means of expansion or contraction. A corresponding form is then displayed on the screen 21b and respective form parameters are saved and/or forwarded to a further calculation device and are used for calculation of process parameters for the production of the food product. In some examples that include movable symbols 40, only the movable symbols 40 may be manipulated in order to change the form. For example, if an outer contour of the displayed food form that is not a movable symbol 40 is moved, then the form may not be changed. Such examples where only the movable symbols 40 may be manipulated in order to change the displayed food form may be advantageous for simplifying calculations for the manipulated food form. However, in other examples, any portion of the outer contour of the displayed food form may be manipulated.

With 42, a confirmation medium is displayed in form of a key, which confirms that the displayed form is all right and that the food product should be produced on the basis of the respective form parameters and the respectively calculated process parameters.

FIG. 2 shows a possible embodiment of a method according to the present disclosure. In a step S1, various form parameters such as the diameter, the tip size or the length are at first and as described before entered with a constant diameter, i.e. the height, either by using the input unit 21a with numerical values or rather by means of changing the product form via the screen 21b. On the basis of respective form parameters, product parameters are calculated for the forming device 10 and the device 10 for ejecting the food strand. Appropriate process parameters can be for example: conveying capacity of the food, i.e. in this case conveying capacity of the conveyor system of the filling machine 10, where applicable also the change of the conveying capacity as a function of time. Also the position of the displacer elements 2a, b, c as a function of time and/or based on the length of the produced food can be set. The displacer elements have each at least one opening 3a, b, c through which the food strand can be moved in the transport direction T, wherein a movement mechanism moves the flat displacer elements in a way that the respective openings are movable in relation to one another so that the cross-section area of the resulting overall opening 4 of the overlapping openings changes according to a desired product cross-section. A respective embodiment will be explained in greater detail in the following with reference to the FIGS. 6 to 7F. Besides the position of the displacer elements as a function of time, also the speed of the displacer elements can be calculated as a function of time, as well as the movement direction of the displacer element. In any case, the forming device is set in a way that the cross-section area of the resulting overall opening over the length of the food product is adapted to the desired food form.

If the process parameters have been calculated in step S2, the form of the food product can be visually displayed at the same time or subsequently in step S3. If the form is not in line with the desired form, the form can be adapted once again in step S1 by changing at least one form parameter. Only if the operator finds that the displayed form is all right, he can confirm for example by means of key 42 that production can be performed on the basis of the selected form and the respective process parameters. In a step S4, production of the food product will then take place by means of the device according to the present disclosure that is activated with the calculated process parameters. Now there is once again the possibility of evaluating the produced products. If required, the product form can be optimized once again while production does not necessarily have to be interrupted and wherein form parameters can be adapted once again in step S1.

FIG. 3 shows a slightly deviating variant of the method according to the present disclosure. As described before, appropriate form parameters can be entered in a step S1. On the basis of respective numerically entered form parameters or rather by changing the form of the graphically displayed food product on the screen, a respective form of the food product is displayed visually in a step S2. As displayed by the arrow, the form parameters can be changed once again in the step S1 if the visually displayed form is not yet all right. If the visual display of the form is all right, it can be confirmed for example by using key 42 that the food should be produced on the basis of respective form parameters. Corresponding process parameters will be calculated as a function of the entered form parameters for the forming device and the device for ejecting the food strand 10, wherein for example either the entered form parameter or the graphic data can be used for calculation. Production will then occur in a step S4, wherein the product can be evaluated once again just as in the method shown in FIG. 2 and, if required, the product form can be optimized. If, as shown in FIGS. 2 and 3 by arrows P₁, the visually displayed form is changed once again through readjustment of parameters, both the form as well as the indication of the form parameters in the display areas 21a and 21b will be updated.

A possible forming device will be explained in greater detail in the following with reference to the FIGS. 6 and 7A-7F.

The forming device has for example at least three displacer elements 2a, b, c that are superimposed in the transport direction T of the food strand, as can be seen for example in FIG. 6 that shows a forming device with three flat displacer elements, here: three flat displacer plates. The respective displacer elements 2a, b, c each have at least one opening 3a, b, c (shown in FIGS. 7A-7F). In the embodiment shown in FIG. 6, the respective displacer elements 2a, b, c have a total of eight openings 4 that are arranged respectively next to one another on the corresponding displacer elements, where openings 4 are formed via alignment of openings 3a, b, c of the displacer elements 2a, b, c.

The forming device 1 further has a movement mechanism 6 for moving of the flat displacer elements 2a, b, c on corresponding curved tracks in a way that the respective openings 3a, b, c can move in relation towards one another so that the cross-section area of the resulting overall opening 4 of the overlapping openings 3a, b, c changes. The movement mechanism 6 in this embodiment has for example a rotary part, here: a rotary disc 9, on whose side area the flat displacer elements 2a, b, c are installed rotatably on coupling points 12a, b, c for example with respectively one bolt. As can be seen in particular in FIG. 6, the flat displacer elements 2a, b, c on a second rotary part, here: rotary disc, are also installed rotatably on respective coupling points, for example by means of bolts, on their opposite ends. Here, the displacer elements are arranged with an even distribution around the circumference of the rotary part 9, e.g. here respectively at a distance of 120°.

In this embodiment, at least one of the rotary parts, here: e.g. the left rotary part 9 shown in FIG. 6, is driven, for example by an engine that is not displayed, in particular a servo engine. The rotary part that is disposed on the other side of the displacer elements 2a, b, c is only used for guiding in this case. Instead of this rotary part, also a respective curve guiding etc. could be provided.

For the sake of simplicity, FIG. 7A only shows a partial area of the forming device, with the displacer elements 2a, b, c in an opening position O, in which the cross-section area of the overall opening 4 has a predetermined maximum cross-section. In this particular embodiment, the individual openings 3a, b, c of the displacer elements 2a, b, c thereby overlap completely. The center M of the resulting overall opening 4 and the center M of the ejection opening 8 of the ejection element align with one another. The maximum overall opening 4 thereby has a cross-section area that is approximately equivalent to the cross-section area of the inserted food strand 5, and/or of the ejection opening 8 that produces the food strand. Hence, accumulation of the food strand can be avoided. The food strand can be ejected through the ejection aperture 8 through the overall opening 4. The displacer element that faces the ejection opening 8 moves closely along the ejection opening with as much leeway as to enable the displacer element to slide freely over the opening.

Out of the opening position shown in FIG. 7A, the individual displacer elements 2a, b, c can move along a curved track while the rotary part 9 turns in the turning direction D. FIG. 7B shows the forming device displayed in FIG. 7A in which the rotary part has turned by an angle a in the turning direction D, here: to the left, around the central axis K.

As can be seen in FIG. 7B, also the openings 3a, b, c move during the movement of the displacer elements along the curved track. As the displacer elements 2a, b, c are arranged in a distributed way on the circumference of the disc 9, the displacer elements move on different curved tracks in a way that the openings 3a, b, c move apart and that the cross-section area of the resulting overall opening 4 becomes smaller. The center M of the resulting overall opening still aligns with the center M of the ejection opening 8. A rounded triangle is formed through a respective overlap of the openings 3a, b, c. FIG. 7C shows the forming device shown in FIG. 7A, 7B, in which the rotary part 9 has been turned further by an angle a of approx. 20° compared to FIG. 7A. As becomes apparent when comparing the FIGS. 7B and 7C, the edges 7 of the openings 3a, b, c, which delimit the overall opening 4, move towards the center M of the overall opening 4 from three sides.

For this example, FIG. 7D shows a rotary angle a of the rotary part 9 of approx. 26°. As becomes clear, the displacer elements 2a, b, c move on respective curved tracks in a way that the openings 3a, b, c overlap in a way that the cross-section area of the resulting overall opening 4, i.e. the intersection of the openings, decreases further and the edges 7 of the openings, which delimit the overall opening 4, move further towards the center M of the overall opening 4. FIG. 7E shows a movement of the rotary part 9 by an angle α□of approx. 37°. Here, the area of the overall opening 4 is zero; this means that the openings 3a, b, c of all displacer elements have no common intersection, i.e. no resulting overall opening, anymore. In this position, the food strand is separated. As displayed in FIG. 7F, the displacer elements 2a, b, c can also move beyond this position (wherein the edges 7 slide past one another and cut off the food product), here: e.g. up to an angle of for example 45° in order to separate the food accurately. Also in this case, there is no overall opening; no opening 3a, b, c intersects with another opening.

Then, the flat displacer elements 2a, b, c can be moved back into the starting position O, as shown in FIG. 7A, from the positions 7f or 7e against the turning direction D. Therefore, the drive part 9 may be driven in two turning directions by means of a servo drive. Due to the installation of the displacer elements described before, they always remain aligned correctly, here: horizontally, so that the respective center M of the overall opening 4 always aligns with the center M of the ejection opening 8, even if multiple strands are produced in parallel to one another, i.e. several ejection openings 8 are arranged in a row.

It is also possible to use more than 3 displacer elements.

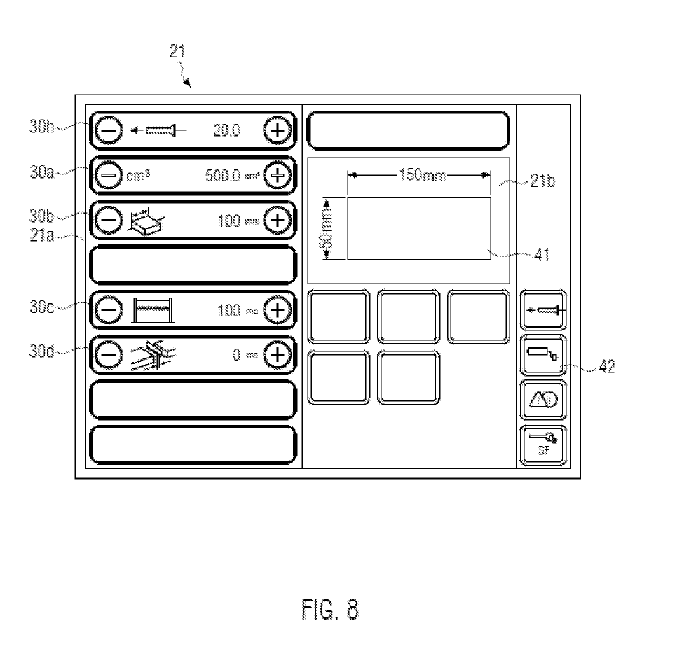

However, the present disclosure is not limited to the forming device described before. The present disclosure is also suitable for example for producing minced meat products. As becomes clear in particular from FIG. 8, form parameters for the minced meat form can be entered via the operating unit 21a or 21b as also explained in connection with the above embodiments. The forming device hereby comprises for example a separator blade that cuts the food product, wherein the separator blade is moved through the food product while e.g. the food product is moved in the transport direction. Through activation of the separator blade, in particular of the position of the separator blade as a function of time or of the traveled ejection path of the minced meat for a specific transport speed, the form of the food product for the minced meat can be influenced (for example slant edges, defined end forms etc. can be produced). For this purpose, for example the volume of the individual minced meat product can be entered in field 30a and the length of the minced meat product in field 30b. In field 30, the duration of the cutting movement from an upper position of the separator blade to a lower position of the separator blade and back is set. Further, the starting time of the movement of the separator blade can be set in field 30d.

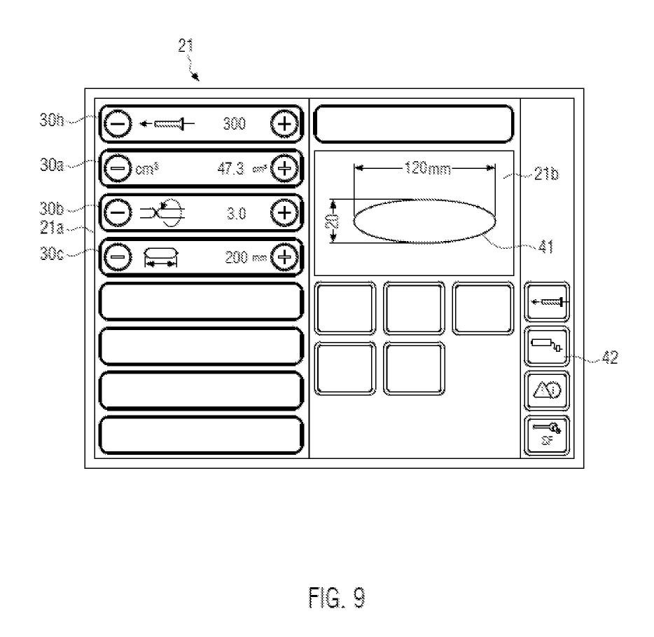

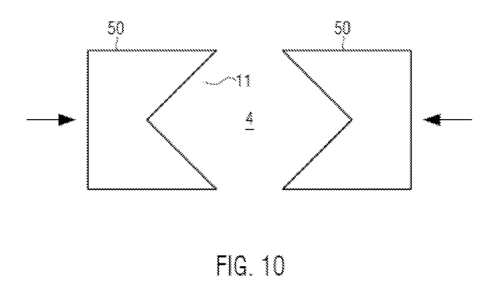

FIG. 9 shows a further embodiment in which for example the form of a sausage, which is ejected through the filling tube of a sausage machine, can be displayed. Here, the forming device comprises for example two separator elements and/or displacer elements 50, as shown for example in FIG. 10, that are located opposite to each other and that encroach in the sausage strand. The displacer elements 50 have openings 11 that are located opposite to one another. The displacer elements 50 move from the outer contour of a produced sausage strand into the sausage strand. The openings 11 together form a throughput opening 4 through which the sausage is transported, wherein the throughput opening is changed as a function of time or of the traveled ejection path of the food product. Hence, a specific sausage tip form can be produced, wherein the respective form is displayed graphically on the screen 21b and can also be changed as in the previous embodiments. In FIG. 9, for example the speed can be set in the input unit 21b in the field 30h. In field 30a, the volume of the produced sausage is set. In field 30b, the number of turnings is entered and the product length can be set in field 30c. The product height results from the set volume and the set product length. The tip form or also the sausage form is derived from the sausage sleeve used and of how firmly it is filled. In the embodiments described before it is also possible to also enter and/or to select at least one process parameter in addition to the form parameters.

This way, the conveying capacity can be set and all remaining process parameters will then be calculated accordingly in order to realize the desired form on the basis of the form parameters. This means that for example the conveying capacity can be changed while the form still remains constant.

1. A method for producing food products that are sleeveless products of a specific form, comprising:
receiving entry of form parameters,
displaying of a form of a food product as a function of the entered form parameters as a 2D or 3D graphic, and
calculating corresponding process parameters as a function of the entered form parameters.

2. The method according to claim 1, wherein the form of the food product is displayed graphically as the function of the entered form parameters, and wherein the corresponding process parameters are calculated subsequently.

3. The method according to claim 1, wherein the form of the food product is displayed graphically as the function of the entered form parameters, and wherein the corresponding process parameters are calculated at the same time.

4. The method according to claim 1, wherein the process parameters are calculated as the function of the entered form parameters, and wherein the form of the food product is displayed graphically afterwards.

5. The method according to claim 1, wherein the graphically displayed form of the food products is modifiable by entering changed form parameters and that a changed graphic display occurs and that respectively changed process parameters are calculated on the basis of the changed form parameters.

6. The method according to claim 1, wherein, if it is determined that the food product is to be produced on the basis of a specific displayed form, a confirmation is entered after which the food will be produced.

7. The method according to claim 1, wherein at least one parameter of the following group is entered as the form parameters:
a length of a formed food product, a diameter of the formed food product, a sausage caliber, a length of a front and/or a rear tip of the food product, a length of the food product with a constant diameter, a change of a diameter as a function of the food product length, a number of the diameter changes per path.

8. The method according to claim 1, wherein the food products are produced with a forming device that is formed in a way that a cross-section area of a throughput opening, through which a food strand is transported for forming, is changed as a function of time or of a traveled ejection path of the food product.

9. The method according to claim 8, wherein the food product is moved and is produced with at least two displacer elements that are superimposed in a transport direction of the food strand and that each have at least one opening through which the food strand is moved in the transport direction, and
wherein the forming device has a movement mechanism for moving the flat displacer elements in a way that respective openings of the displacer elements are moved in relation to one another so that a cross-section area of a resulting overall opening of overlapping openings of the flat displacer elements changes.

10. The method according to claim 9, wherein there are more than two flat displacer elements.

11. The method according to claim 1, wherein at least one parameter from the following group is calculated as the process parameters: a conveying capacity of the food product, a conveying capacity as a function of time, a speed of displacer elements as a function of time, a direction of a movement of the displacer elements, a position of the displacer elements as a function of time or of a traveled ejection path of the food product, a position of a separator blade as a function of time or of the traveled ejection path of the food product, and a conveying speed of the food product.

12. The method according to claim 1, wherein the form parameters are entered as numerical values via an input unit and/or through change of the form of the graphically displayed food product on a graphic user interface of a screen, by means of a touchscreen or by moving of a symbol that is displayed on the graphic user interface of the screen.

13. The method according to claim 1, wherein the food products are minced meat products, wherein the food products are formed with a forming device that is formed in a way that a separator blade moves into a minced meat strand and separates the minced meat strand, and wherein a position of the separator blade is changed as a function of time or of a traveled ejection path of the food product and the calculated corresponding process parameters.

14. The method according to claim 1, wherein at least one process parameter is entered, and wherein further process parameters are calculated as a function of the at least one entered process parameter and the entered form parameters, the method further comprising adjusting an actuator for adjusting a machine forming the food products based on the calculated parameters.

15. The method according to claim 14, wherein the at least one process parameter entered is a conveying capacity.

16. A device for producing food products that are sleeveless products via receiving entry of form parameters, displaying of a form of a food product as a function of the entered form parameters as a 2D or 3D graphic, and calculating corresponding process parameters as a function of the entered form parameters, the device comprising:
a device for ejection of a food strand,
a forming device for forming of food products,
an input unit for entering the form parameters,
a first calculation device for calculation of process parameters as a function of the form parameters,
a screen for display of the form of the food product as the 2D or the 3D graphic as a function of the entered form parameters.

17. The device according to claim 16, wherein a second calculation device is provided for calculation of graphic data as a function of the entered form parameters.

18. The device according to claim 16, wherein the food products are produced with the forming device that is formed in a way that a cross-section of a throughput opening, through which the food strand is transported, is changed as a function of time or of a traveled ejection path of the food product, and
wherein the device preferably has at least two flat displacer elements that are superimposed in a transport direction of the food strand and that have each at least one opening, through which the food strand is moved in the transport direction, and a movement mechanism for moving the flat displacer elements in a way that the respective openings are moved in relation to one another so that a cross-section area of a resulting overall opening of overlapping openings of the flat displacer elements changes.

19. The device according to claim 16, wherein the input unit is either formed in a way that numerical values are entered and/or
that the form of the graphically displayed food product is modifiable on the screen that is a touchscreen or that has at least one movable symbol on the user interface.

20. The device according to claim 16, wherein a confirmation medium is provided to confirm that the food product is produced on the basis of the displayed food product.
